(19) United States
(12) Patent Application Publication
(10) Pub. No.: US 2019/0268611 A1
(43) Pub. Date: Aug. 29, 2019

(54) Intelligent Mode Assignment In Video Coding

(71) Applicant: MediaTek Inc., Hsinchu City (TW)

(72) Inventors: Chun-Chia Chen, Hsinchu City (TW); Chih-Wei Hsu, Hsinchu City (TW)

(21) Appl. No.: 16/280,037

(22) Filed: Feb. 20, 2019

Related U.S. Application Data
(60) Provisional application No. 62/634,983, filed on Feb. 26, 2018.

(51) Int. Cl. H04N 19/196; H04N 19/176; H04N 19/103; H04N 19/157; H04N 19/46

(52) U.S. Cl. CPC H04N 19/196; H04N 19/176; H04N 19/46; H04N 19/157; H04N 19/103

(57) ABSTRACT

A video codec that intelligently assigns a mode setting to a current block of pixels of a video picture of a video sequence when the current block is encoded or decoded by merge mode is provided. The current block has one or more coded neighboring blocks. Each coded neighboring block of the one or more coded neighboring blocks is coded by applying a respective mode setting that is specified for each neighboring block of the one or more coded neighboring blocks. The video codec identifies a set of one or more candidate predictors. The video codec specifies a mode setting for the current block based on the selected candidate predictor and mode settings that are specified for the one or more coded neighboring blocks. The video codec encodes or decodes the current block by using a selected candidate predictor and applying the mode setting specified for the current block.

### CROSS REFERENCE TO RELATED PATENT APPLICATION(S)

The present disclosure is part of a non-provisional application that claims the priority benefit of U.S. Provisional Patent Application No. 62/634,983, filed on 26 Feb. 2018. Content of above-listed application is herein incorporated by reference.

### TECHNICAL FIELD

The present disclosure relates generally to video processing. In particular, the present disclosure relates to assigning mode settings to pixel blocks.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated discrete cosine transform (DCT)-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs). Each PU corresponds to a block of pixels in the CU.

To achieve the best coding efficiency of hybrid coding architecture, HEVC employs intra-prediction and/or inter-prediction modes for each PU. For inter-prediction modes, motion information is used to reconstruct temporal reference frames, which are used to generate motion compensated predictions. Motion information may include motion vectors, motion vector predictors, motion vector differences, reference indices for selecting reference frames, etc.

There are three types of inter-prediction modes: skip mode, merge mode, and advanced motion vector prediction (AMVP) mode. When a PU is coded in AMVP mode, motion vectors (MVs) used for motion-compensated prediction of the PU are derived from motion vector predictors (MVPs) and motion vector differences (MVDs, or residual motion data) according to MV=MVP+MVD. An index that identifies the MVP selection is encoded and transmitted along with the corresponding MVD as motion information. When a PU is coded in either skip mode or merge mode, no motion information is transmitted except the merge index of the selected candidate. Skip mode and merge mode utilize motion inference methods (MV=MVP+MVD where MVD is zero) to obtain the motion information from spatially neighboring blocks (spatial candidates) or collocated blocks in temporally neighboring pictures (temporal candidates) that are selected from reference frame list List0 or List1 (indicated in slice header). In the case of a skip PU, the residual signal for the block being coded is also omitted. To relay motion information for a pixel block under HEVC by using AMVP, merge mode, or skip mode, an index is used to select an MVP (or motion predictor) from a list of candidate motion predictors. In merge/skip mode, a merge index is used to select an MVP from a list of candidate motion predictors that includes four spatial candidates and one temporal candidate. The merge index is transmitted, but motion predictors are not transmitted.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a video codec that intelligently assigns a mode setting to a current block of pixels of a video picture of a video sequence when the current block of pixels is encoded or decoded by merge mode. The mode setting assigned to the current block of pixels may be a flag for applying a linear model that includes a scaling factor and an offset to pixel values of the current block of pixels.

The current block of pixels has one or more coded neighboring blocks. Each coded neighboring block of the one or more coded neighboring blocks is coded by applying a respective mode setting that is specified for each neighboring block of the one or more coded neighboring blocks. The video codec identifies a set of one or more candidate predictors. Each candidate predictor of the one or more candidate predictors is associated with one of the one or more coded neighboring blocks of the current block of pixels. The video codec selects a candidate predictor from the set of one or more candidate predictors. The video codec specifies a mode setting for the current block of pixels based on the selected candidate predictor and mode settings that are specified for the one or more coded neighboring blocks. The video codec encodes or decodes the current block of pixels by using the selected candidate predictor and applying the mode setting specified for the current block of pixels.

In some embodiments, the mode setting specified for the current block of pixels is a toggle of the respective mode setting specified for one or the one or more coded neighboring blocks that is associated with the selected candidate predictor. The video codec may identify a subset of one or more candidate predictors among the set of one or more candidate predictors according to a predetermined rule. The mode setting specified for the current block of pixels is a toggle of the mode setting specified for one of the one or more coded neighboring blocks that is associated with the selected candidate predictor when the selected candidate predictor is in the identified subset. The selected candidate predictor may have motion information for multiple sub-blocks of the current block of pixels.

In some embodiments, when the mode settings specified for respective one or more of the one or more coded neighboring blocks associated with the subset of candidate predictors share a same value and when the selected candidate predictor is in the identified subset of one or more candidate predictors, the mode setting specified for the current block of pixels is a toggle of the mode setting specified for one of the one or more coded neighboring blocks that is associated with the selected candidate predictor. The identified subset of one or more candidate predictors may include two or more candidate predictors having motion information for a plurality of sub-blocks of the current block of pixels.

In some embodiments, the mode setting specified for the current block of pixels is determined based on a count of neighboring blocks of the one or more coded neighboring blocks sharing a same value for their respective mode settings.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 conceptually illustrates specifying a mode setting for a current block based on mode settings that are specified for neighboring blocks of the current block.

FIG. 2 illustrates assigning the mode setting to a current block by toggling the mode setting inherited from the selected candidate.

FIG. 3 illustrates assigning the mode setting to a current block by toggling the mode setting inherited from the selected candidate if the selected candidate is in an identified subset of merge candidates.

FIGS. 4a-b each conceptually illustrates assigning the mode setting to a current block based on whether the mode settings of an identified subset of the merge candidates share a same value.

FIG. 5 illustrates surrounding CUs or minimum blocks in the left and top of a current block.

FIG. 6 illustrates templates to the top and to the left of the current CU and of the reference CU.

FIG. 7 illustrates an example video encoder that assigns a mode setting (e.g., LIC flag) to a current block of pixels based on mode settings of neighboring blocks associated with candidate predictors.

FIG. 8 illustrates a portion of the video encoder that assigns a mode setting to a current block of pixels.

FIG. 9 illustrates an example video decoder that assigns a mode setting (e.g., LIC flag) to a current block of pixels based on mode settings of neighboring blocks associated with candidate predictors.

FIG. 10 illustrates a portion of the video decoder that assigns a mode setting to a current block of pixels.

FIG. 11 conceptually illustrates a process for assigning a mode setting to a current block of pixels based on mode settings of neighboring blocks associated with merge candidates.

FIG. 12 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

Inter-prediction is efficient if the scenes are stationary and motion estimation can easily find similar blocks with similar pixel values in the temporal neighboring frames. However, frames may be shot with different lighting conditions. Consequently, the pixel values between frames will be different even if the content is similar and the scene is stationary. Methods such as Neighboring-derived Prediction Offset (NPO) and Local Illumination Compensation (LIC) may be used to add prediction offset to improve the motion compensated predictors. The offset can be used to account for different lighting conditions between frames.

For NPO, the offset is derived using neighboring reconstructed pixels (NRP) and extended motion compensated predictors (EMCP). The patterns chosen for NRP and EMCP are N pixels left and M pixels above to the current PU, where N and M is a predetermined value. The patterns can be of any size and shape and can be decided according to any encoding parameters, such as PU or CU sizes, as long as they are the same for both NRP and EMCP. Then the offset is calculated as the average pixel value of NRP minus the average pixel value of EMCP. This derived offset will be unique over the PU and applied to the whole PU along with the motion compensated predictors. First, for each neighboring position, the individual offset is calculated as the corresponding pixel in NRP minus the pixel in EMCP. Second, when all individual offsets are calculated and obtained, the derived offset for each position in the current PU will be the average of the offsets from the left and above positions.

For LIC, a linear model having a scaling factor “a” and an offset “b” is derived by referring to the neighbor samples of a current block and the neighboring samples of a reference block. The LIC linear model weighs the motion compensation result of the current block by *a+b, then rounds and shifts. The neighboring samples may come from a L-shape region to the top and left of the current block and the reference block. Least square method may be used to derive the scaling factor “a” and the offset “b” from neighboring samples. As a block is encoded or decoded, a video codec may compute a set of LIC parameters using lower and edge pixels. The computed LIC parameters may be stored in a frame level map for use for encoding or decoding subsequently blocks.

Details of LIC can be found in the document “JVET-C1001, title: Algorithm Description of Joint Exploration Test Model 3” by Joint Video Exploration Team (JVET) of ITU-T SG 16 WP 3 and ISO/IEC JTC 1/SC 29/WG 11, 3rd Meeting: Geneva, CH, 26 May-1 Jun. 2016.

LIC and NPO are examples of mode settings that can be applied to a block of pixels as it is being encoded or decoded. These mode settings may control whether the video codec perform certain additional processing on the pixels of the block after motion compensation (MC). A mode setting of a block for a particular function such as LIC or NPO may be a flag that enables or disables the particular function for the block. A mode setting may also include multiple bits to represent a range of more than two possible values.

A mode setting for a block of pixels, such as a LIC flag that enables or disables applying LIC linear model to the block may be adaptive turned on or off. A mode setting of a current block may be inherited from a temporally or spatially neighboring block of the current block. Specifically, when the current block is inter-predicted by merge mode, the mode setting of the selected merge candidate (i.e., the mode setting of the neighboring block that provides the selected merge candidate) is assigned as the mode setting of the current block.

Some embodiments of the disclosure provide a video codec that intelligently assigns a mode setting to a current block when the current block is encoded or decoded by merge mode. The video codec selects a candidate predictor (e.g., a merge candidate for merge mode) from a set of one or more candidate predictors (e.g., a list of merge candidates). Each candidate predictor is associated with (e.g., provided by) one of the coded neighboring blocks of the current block. The video codec specifies a mode setting for the current block of pixels based on mode settings that are specified for neighboring blocks of the current block. The video codec then encodes or decodes the current block of pixels by using the selected candidate predictor and applying the mode setting specified for the current block.

### I. Assigning Mode Setting to the Current Block

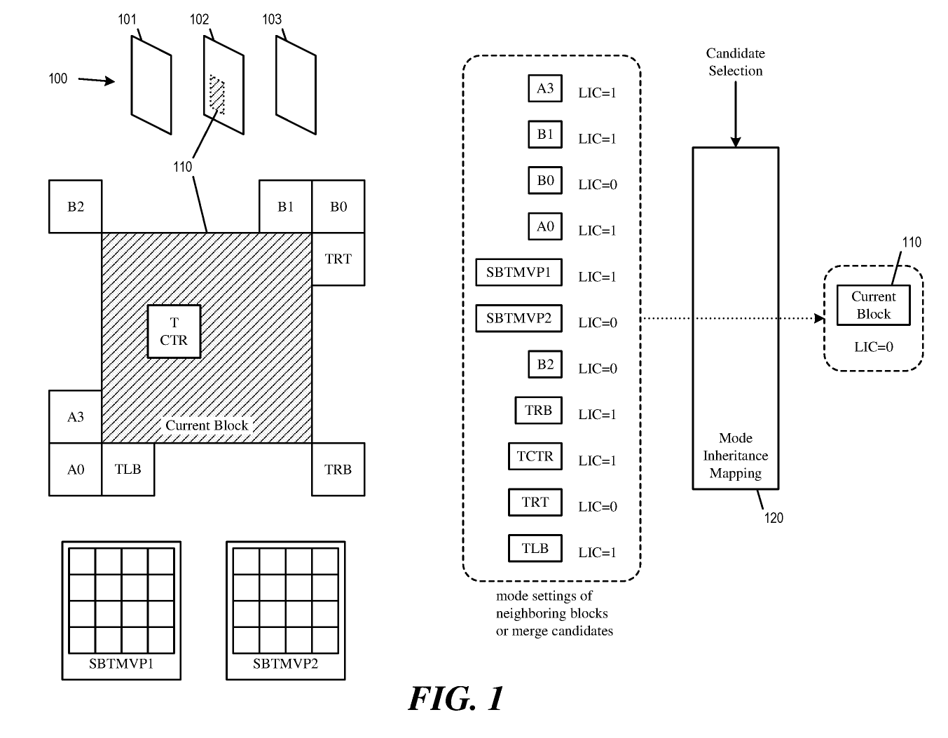

FIG. 1 conceptually illustrates specifying a mode setting for a current block based on mode settings that are specified for neighboring blocks of the current block. The figure illustrates a video sequence 100 that includes video frames 101, 102 and 103. The video frame 102 is a currently being coded by the video codec, while the video frames 101 and 103 are previously coded frames that are used as reference frames for coding the video frame 102. The video frame 101 is temporally prior to the video frame 102 (e.g., scheduled to be displayed before the video frame 102 or having picture order count that is prior to the video frame 102). The video frame 103 is temporally after the video frame 102 (e.g., scheduled to be displayed after the video frame 102 or having picture order count that is after the video frame 102). The currently coded video frame 102 is divided into blocks of pixels as coding units (CU) or prediction units (PU), including a block 110 that is currently being coded (the current block 110) by the video codec.

The current block 110 is being coded by merge mode. As illustrated, the current block includes several temporal and spatial neighbors, including spatial neighbors A0, A3, B0, B1, B2 and temporal neighbors TCTR (center), TRT (right-top), TLB (left-bottom), and TRB (right-bottom). The spatial neighbors are pixel blocks in the current frame 102 that neighbor the current block at the top or at the left. The temporal neighbors are pixel blocks in the reference frames 101 or 103 that are collocated with the current block or neighboring the position of the current block at the bottom or at the right. For merge mode, each of these temporal and spatial neighbors provide a candidate predictor or a merge candidate in a list of merge candidates. When the video codec selects a merge candidate, the motion information of the temporal or spatial neighbor that corresponds to the selected merge candidate is used to perform inter-prediction for the current block 110.

In some embodiments, the list of merge candidates may include a Sub-PU Temporal Motion Vector Prediction (Sub-PU TMVP) candidate. To derive the Sub-PU TMVP candidate, the current PU is partitioned into multiple Sub-PUs. The video codec performs an algorithm to identify corresponding temporal collocated motion vectors for each Sub-PU. In some embodiments, the list of merge candidates may include two or more Sub-PU TMVP candidates. Different Sub-PU TMVP candidates are derived by different algorithms. Examples of the algorithms used to derive Sub-PU TMVP candidate will be described in Section III below. In the example of FIG. 1, the list of merge candidates includes two Sub-PU TMVP candidates: SBTMVP1 and SBTMVP2. These two Sub-PU TMVP candidates of the current block are generated by different algorithms.

Each of the spatial and temporal neighbors may have a mode setting that specifies whether to performing certain additional processing after motion compensation, such as a flag for enabling LIC or NPO. In the example of FIG. 1, merge candidates A0, A3, B0, B1, B2, TCTR, TRT, TRB, TLB, SBTMVP1, SBTMVP2 all have mode settings or flags specifying whether LIC is performed for those neighboring blocks. For example, the LIC flag of A3 is set to 1, indicating that LIC is performed when reconstructing the pixels of the A3 neighbor block. The LIC flag of B0 is set to 0, indicating that LIC is not performed when reconstructing the pixels of the B0 neighbor block.

As mentioned, in some embodiments, the video codec specifies a mode setting for the current block based on mode settings of neighboring blocks. As illustrated, the video codec implements a mode inheritance mapping module 120 that assigns a value to the LIC flag of the current block 110 by mapping the LIC flags of the different spatial and temporal neighbors or merge candidates into the LIC flag of the current block.

In some embodiments, for each temporal or spatial candidate in the list of merge candidates, the video codec inherits the mode setting from the corresponding neighboring blocks and toggles the mode setting of the merge candidate selected for coding the current block (“toggling” means changing the flag or mode setting to 1 if it is originally 0, or, changing the flag or mode setting to 0 if it is originally 1). More generally, in some embodiments, the mode setting specified for the current block is a toggle of the mode setting specified for a neighboring block that is associated with the selected candidate predictor.

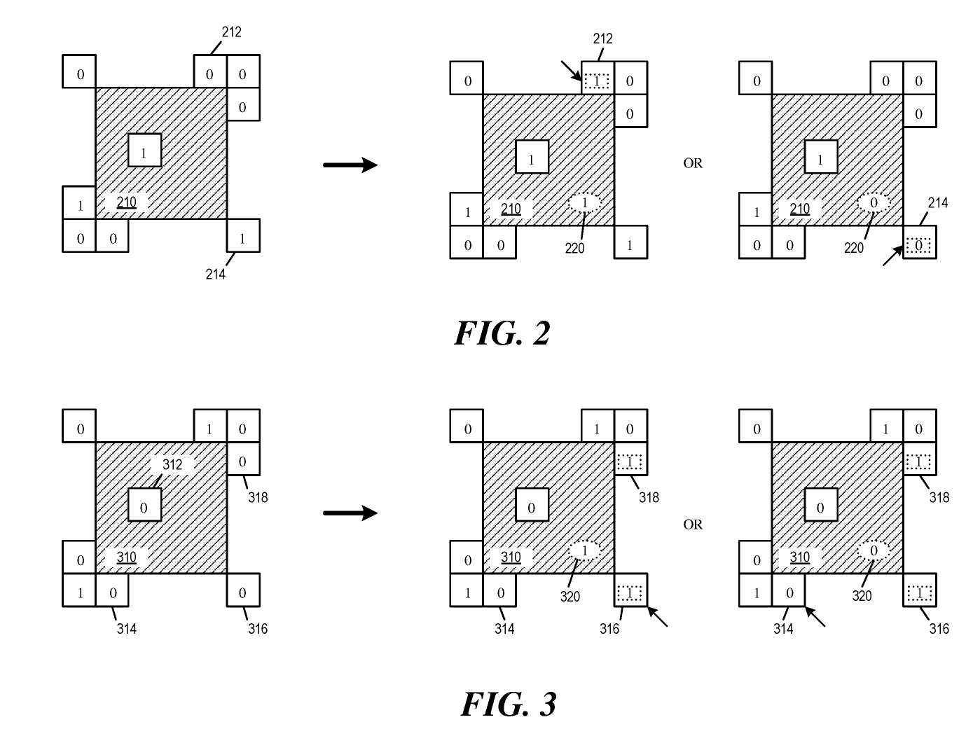

FIG. 2 illustrates assigning the mode setting to a current block by toggling the mode setting inherited from the selected candidate. The figure conceptually illustrates a current block 210 and its spatial and temporal neighbors that correspond to the merge candidates of the current block. The spatial and temporal neighbors are coded according to the mode settings (e.g., LIC flags) of those neighboring blocks. In the example, the mode setting of the merge candidate 212 (spatial candidate B1) is set to 0, and the mode setting of the merge candidate 214 (temporal candidate TRB) is set to 1. When the merge candidate 212 is selected for merge mode, the mode setting 220 of the current block 210 is set to 1, which is the toggle of the mode setting of the merge candidate 212. When the merge candidate 214 is selected for merge mode, the mode setting 220 of the current block 210 is set to 0, which is the toggle of the mode setting of the merge candidate 214.

In some embodiments, the mode setting of a certain temporal candidate type is toggled for inheriting by the current block. For example, the video codec may toggle the mode setting of the TRT candidate but not the mode settings of TCTR, TLB, TRB. In other words, when the TRT candidate is selected for merge mode, the mode setting of the current block is assigned to be the toggle of the TRT candidate; when another temporal candidate is selected for merge mode (one of TCTR, TLB, or TRB), the mode setting of the current block is assigned to inherit mode setting of the selected candidate without change. In some embodiments, the mode settings of two or more certain temporal candidate type are toggled for inheriting by the current block. For example, the video codec may toggle the mode setting of the TRT and TCTR candidates but not the mode settings of TLB, TRB candidates. More generally, the video codec identifies a subset of the merge candidates according to a predetermined rule, and the mode setting assigned to the current block is a toggle of the mode setting of the selected merge candidate when the selected merge candidate is in the identified subset. As long as both the decoder and the encoder agree on the predetermined rule, the subset may include one or more of any arbitrary spatial or temporal merge candidates.

FIG. 3 illustrates assigning the mode setting to a current block by toggling the mode setting inherited from the selected candidate if the selected candidate is in an identified subset of merge candidates. The figure conceptually illustrates a current block 310 and its spatial and temporal neighbors that correspond to the merge candidates of the current block. The spatial and temporal neighbors are coded according to the mode settings (e.g., LIC flags) of those neighboring blocks.

In the example, mode settings of temporal candidates 312, 314, 316, and 318 (TCTR, TLB, TRB, and TRT, respectively) are all 0. A predefined rule (agreed by both encoder and decoder) identifies a subset of the merge candidates that includes 316 (TRB) and 318 (TRT). The video codec toggles the mode settings of the candidates in the subset (316 and 318) for the current block 310 to inherit but not the mode settings of other merge candidates. As illustrated, if temporal candidate 316 (or 318) is selected for merge mode, the mode setting 320 of the current block 310 is set to 1 by toggling the mode setting of 316 (or 318). If the selected merge candidate is outside of the subset that includes 316 and 318 (e.g., 314), the mode setting 320 of the current block 310 inherits the mode setting without toggling.

In some embodiments, the video codec toggles the mode setting of a temporal candidate for the current block to inherit if the mode settings of all available temporal candidates share a same value (all 1 or all 0). Conversely, if the mode settings of all available temporal candidates do not share a same value, the video codec does not toggle the mode setting of any temporal candidate. In some embodiments, the video codec toggles the mode settings of two or more temporal candidates if all available temporal candidates share a same value. The toggled mode setting is inherited by the current block if one of the toggled merge candidates is selected for merge mode inter-prediction. More generally, the video codec identifies a subset of one or more candidate predictors according to a predetermined rule (that is agreed upon by both encoder and decoder). When the mode settings specified for identified subset of candidates share a same value and the selected candidate predictor is one of the identified subset of candidate predictors, the mode setting specified for the current block is a toggle of the mode setting specified for the selected merge candidate. The video codec may identify the subset of merge candidates before or after the list of merge candidates is pruned to remove certain merge candidates.

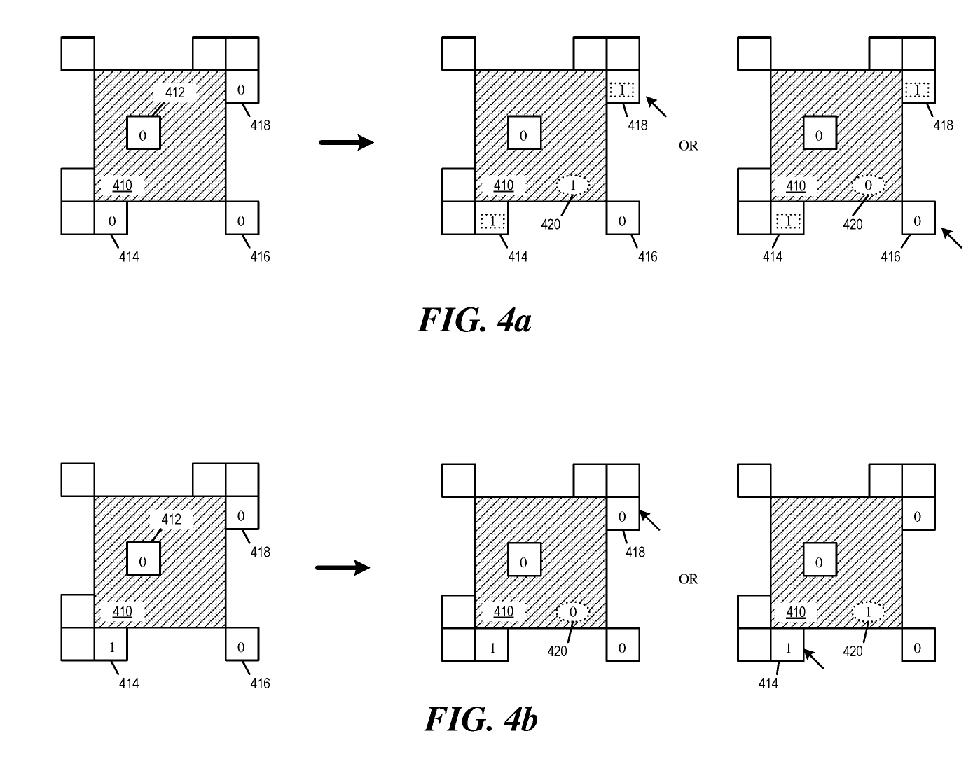

FIGS. 4a-b each conceptually illustrates assigning the mode setting to a current block based on whether the mode settings of an identified subset of the merge candidates share a same value. The figure conceptually illustrates a current block 410 and its spatial and temporal neighbors that correspond to the merge candidates of the current block. In the examples, the video codec examines the mode settings of temporal candidates 412, 414, 416, and 418 (TCTR, TLB, TRB, and TRT) to determine whether to toggle the mode settings of merge candidates 414 and 418 for the current block to inherit.

In the example of FIG. 4a, the mode settings of the candidates in the identified subset (temporal candidates 412, 414, 416, and 418) are all 0. The mode settings of candidates 414 and 418 are toggled to 1 if inherited by the current block 410. Thus, when the merge candidate 418 is selected, the mode setting of the current block inherits the toggled value, i.e., 1. On the other hand, when the merge candidate 416 is selected, the mode setting 420 of the current block 410 inherits the original value, i.e., 0.

In the example of FIG. 4b, the mode settings of the candidates in the identified subset of 412, 414, 416, and 418 are not all 0 (the mode setting of the temporal candidate 414 is 1), the mode settings of candidates 414 and 418 are not altered. Thus, regardless of which merge candidate is selected, the mode setting 420 of the current block inherits the original mode setting of the selected merge candidate without toggling.

As mentioned, the list or merge candidates may include one or more sub-PU TMVP candidates, such as SBTMVP1 and SBTMVP2 of FIG. 1. Each of these Sub-PU TMVP candidates includes multiple sets of motion information for multiple Sub-PUs. This is in contrast with “normal” candidates, which has one set of motion information for one PU or one CU.

In some embodiments, when there are two Sub-PU TMVP candidate available in the list of merge candidates, the mode setting (e.g., LIC or NPO flag) of one Sub-PU TMVP candidate is set to be the inverse of the other Sub-PU TMVP candidate for the current block to inherit.

In some embodiments, the video codec toggles the mode setting of a certain sub-PU TMVP candidate type. In some embodiments, the video codec toggles the mode setting of two or more Sub-PU TMVP candidate types. More generally, the video codec may identify one, two, or more sub-PU TMVP candidates according to a predetermined rule, and the mode setting assigned to the current block is a toggle of the mode setting of the selected sub-PU TMVP candidate when the selected sub-PU TMVP candidate is one of the identified sub-PU TMVP candidates.

In some embodiments, the video codec toggles the mode setting of a Sub-PU TMVP candidate if the mode settings of all available Sub-PU TMVP candidates share a same value (all 1 or all 0). Conversely, if the mode settings of all available Sub-PU TMVP candidates do not share a same value, the video codec does not toggle the mode setting of any Sub-PU TMVP candidate. In some embodiments, the video codec toggles the mode settings of two or more Sub-PU TMVP candidates if all available Sub-PU TMVP candidates share a same value. The toggled mode setting is inherited by the current block if one of the toggled Sub-PU TMVP candidate is selected for merge mode inter-prediction of the current block.

As long as both the decoder and the encoder agree on the predefined rule, the predetermined rule may identify one or more of any arbitrary Sub-PU TMVP or normal candidates, before or after pruning removes certain merge candidates.

In some embodiments, the mode setting of the current block is determined based on a count of neighboring blocks sharing a same value for their corresponding mode settings. The video codec may count the number of CUs surrounding (left and/or top neighboring of) the current CU that have their mode settings (LIC or NPO flags) set to 1. The video codec may count the number of minimum blocks (minimum block may be 4×4 or another size) surrounding the current CU that have their mode settings set to 1.

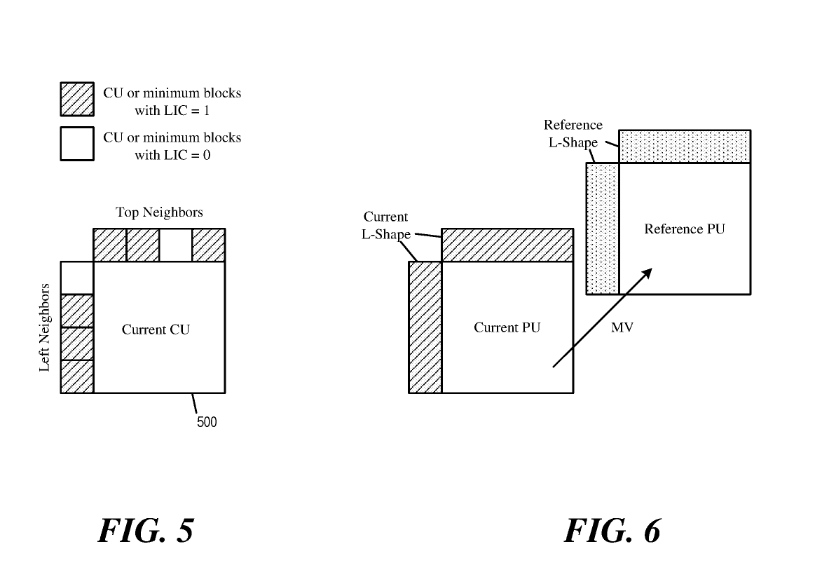

FIG. 5 illustrates spatial surrounding CUs or minimum blocks of a current block 500. The CUs or minimum blocks to the left and top of the current block 500 having mode settings (LIC flags) set to 1 are illustrated as shaded. If the number or percentage of spatial surrounding CUs or minimum blocks with mode settings set to 1 is larger than a predefined threshold (e.g., 70%), the video codec may set the mode setting of one of the normal temporal candidates or one of the Sub-PU TMVP candidates to 1 for the current block 500 to inherit. Otherwise, mode settings of the candidates stay unchanged for the current block 500 to inherit.

In some embodiments, the video codec determines the mode settings (e.g., LIC or NPO flags) of one or more normal temporal candidates and/or Sub-PU TMVP candidates for the current block to inherit based one or more of the following conditions: (1) if most of the spatial surrounding CUs (or minimum blocks) have their mode settings at 1 (e.g., in LIC mode); (2) if most of the spatial surrounding CUs (or minimum blocks) of the current block have their mode settings at 0 (e.g., not in LIC mode); (3) if all of the normal temporal candidates have the same mode setting (e.g., all in LIC mode or none in LIC mode); or (4) if all of the Sub-PU TMVP candidates have the same mode setting (either all in LIC mode or none in LIC mode). In some embodiments, the conditions (1), (2), (3), (4) are all used to determine the mode settings of merge candidates for the current block to inherit. In some embodiments, only a subset of the conditions (1), (2), (3), and (4) are used to determine the mode settings of merge candidates for the current block to inherit.

In some embodiments, the video codec may determine the mode setting (e.g., the LIC/NPO flag) by comparing templates to the top and to the left of the current block. FIG. 6 illustrates templates to the top and to the left of the current CU and of the reference CU. Left and top neighboring pixels of the current CU (current L-shape) and the left and top neighboring pixels of a reference CU (reference L-shape) are used to determine the mode settings of the current CU. The location of the reference CU is a translational offset by motion vector from the location of the current CU.

In some embodiments, if the difference between the current L-shape and the reference L-shape is too large (more than a predefined threshold), the video codec sets the LIC/NPO flag of current merge candidate to 1. In some embodiments, if the difference between the current L-shape and the reference L-shape is too small (less than a predefined threshold), the video codec sets the LIC/NPO flag of current merge candidate to 0. The difference between the current L-shape and the reference L-shape may be computed by SAD (Sum of absolute difference) or another type of difference metric.

### II. Deriving Linear Model for LIC

When deriving a LIC linear model for a CU, pixels of the top neighboring side and the left neighboring side are sampled for deriving the “a” parameter (or alpha, which is weighting) and the “b” parameter (or beta, which is offset) in the linear model. In some embodiments, the pixels from the top neighboring side and from the left neighboring side are sub-sampled such that the number of pixels sampled from the top and from the left are the same regardless of whether the width of the CU is the same as the height of the CU. For example, if current CU is 128×8 (width 128, height 8), the number of pixel samples taken from the top neighboring side is 8 and the number of pixel samples taken from the left neighboring side is also 8. The pixel samples taken from the top neighboring side are sub-sampled (1/16 sampling rate) while the pixel samples taken from the left are not. In other words, for a narrow CU, the large side is weighted the same in linear model as short side even though the large side has many more pixels than the short side.

In some embodiments, when generating a LIC linear model (to compute the “a” and “b” parameters) for a narrow CU, the video codec samples more pixels in the larger side than in the shorter side. In some embodiments, the video codec samples the larger side and the shorter side at the same sampling rate. (Larger side is defined as the larger neighboring side of top side or left side of current CU.) For example, for a 128×8 CU (width 128, height 8), the top neighboring side is the larger side.

In some embodiments, when generating the LIC linear model for a very narrow CU in which the CU width is greater than a threshold*CU height or the CU height is greater than a threshold*CU width, (the threshold may be 2, 4, 8, or any power-of-2 number), only the larger side edge pixels are used for generating the LIC linear model while the shorter edge pixels are discarded.

For example, if the threshold is 16 and the size of the CU is 128×8, only the top neighboring side is used for generating the LIC linear model and pixels from the left neighboring side are discarded (because 8×16<=128). If the threshold is 16 and the size of the CU is 128×64, then pixels in both the top neighboring side and the left neighboring side are sampled when generating LIC linear model (because 64×16>128).

The foregoing proposed method can be implemented in encoders and/or decoders. For example, the proposed method can be implemented in an inter-prediction module of an encoder, and/or a inter prediction module of a decoder.

### III. Sub-PU TMVP Candidates

To improve the coding efficiency, the list of merge candidates includes one or more Sub-PU TMVP candidates for merge mode. For a Sub-PU TMVP candidate, the current PU is partitioned into many Sub-PUs, and the corresponding temporal collocated motion vectors are identified for each Sub-PU. The current PU of size M×N has (M/P)×(N/Q) sub-PUs, each sub-PU is of size P×Q, where M is divisible by P, and N is divisible by Q. An algorithm for deriving a Sub-PU TMVP is described as follows.

Step 1: for the current PU, the Sub-PU TMVP mode finds an “initial motion vector”, which is denoted it as vec_init. By definition, the vec_init is the first available list of the first available spatial neighboring block. For example, if the first available spatial neighboring block has L0 and L1 MV, and LX is the first list for searching collocated information, then the vec_init uses L0 MV if LX=L0, L1 if LX=L1. The value of LX (L0 or L1) depends on which list (L0 or L1) is better for collocated information, if L0 is better for collocated information (e.g., POC distance closer than L1), then LX=L0, and vice versa. LX assignment can be slice level or picture level.

A collocated picture searching process is used to find a main collocated picture for all sub-PU in the Sub-PU TMVP mode. The main collocated picture is denoted as main colpic. The collocated picture searching process searches the reference picture selected by the first available spatial neighboring block, and then searches all reference picture of current picture. For B-slices, the searching process starts from L0 (or L1), reference index 0, then index 1, then index 2, and so on. If the searching process finishes searching L0 (or L1), it then searches another list. For P-slices, the searching process searches the reference picture selected by the first available spatial neighboring block, and then searches all reference picture of current picture of the list starting from reference index 0, then index 1, then index 2, and so on.

For each searched picture, the collocated picture searching process performs availability checking for motion information. When performing availability checking, a scaled version of vec_init (denoted as vec_init scaled) is added to an around-center position of the current PU. The added position is then used to check for prediction type (intra/inter) of the searched picture. The around-center position can be (i) the center pixel (PU size M*N, center=position (M/2, N/2)), (ii) the center sub-PU's center pixel, or (iii) a combination of (i) and (ii) depending on the shape of the current PU, or (iv) some other position. If the prediction type is an inter type, then the motion information is available (availability is true). if the prediction type is an intra type, then the motion information is not available (availability is false). When the searching process completes availability checking, if the motion information is available, then current searched picture is recorded as the main collocated picture. If the motion information is not available, then the searching process proceeds to search next picture.

The collocated picture searching process performs MV scaling to create the scaled version of vec_init (i.e., vec_init scaled) when the reference picture of the vec_init is not the current reference picture. The scaled version of vec_init is created based on the temporal distances between the current picture, the reference pictures of the vec_init, and the searched reference picture.

Step 2: For each sub-PU, the Sub-PU TMVP mode further finds an initial motion vector for the sub-PU, which is denoted as vec_init_sub_i (i=0 ((M/P)×(N/Q)−1)). By definition, vec_init_sub_i=vec_init scaled.

Step 3: For each sub-PU, the Sub-PU TMVP mode finds a collocated picture for reference list 0 and a collocated picture for reference list 1. By definition, there is only one collocated picture (i.e., main colpic) for reference list 0 and reference list 1 for all sub-PUs of the current PU.

Step 4: For each sub-PU, the Sub-PU TMVP mode finds collocated location in the collocated picture according to:

collocated location x=sub-PU_i_x+integer(vec_init_sub_i_x)+shift_x

collocated location y=sub-PU_i_y+integer(vec_init_sub_i_y)+shift_y

The term sub-PU_i is the current sub-PU. The term sub-PU_i_x is the horizontal left-top location of sub-PU_i inside the current picture (integer location); sub-PU_i_y is the vertical left-top location of sub-PU_i inside the current picture (integer location); vec_init_sub_i_x is the horizontal part of vec_init_sub_i (integer portion only); vec_init_sub_i_y is the vertical part of vec_init_sub_i (integer portion only); shift_x is a shift value that can be half of sub-PU width; and shift_y is a shift value that can be half of sub-PU height.

Step 5: For each sub-PU, the Sub-PU TMVP mode finds the motion information temporal predictor, which is denoted as SubPU_MI_i. The SubPU_MI_i is the motion information (MI) from collocated_picture_i_L0 and collocated_picture_i_L1 on the collocated location calculated in Step 4. The MI of a collocated MV is defined as the set of {MV_x, MV_y, reference lists, reference index, other merge-mode-sensitive information}. The merge-mode sensitive information may information such as include local illumination compensation flag. MV_x and MV_y may be scaled according to the temporal distances between collocated picture, current picture, and reference picture of the collocated MV.

As mentioned, in some embodiments, multiple Sub-PU TMVP Candidates are added to the merge candidate list. Different algorithms are used to derive the different Sub-PU TMVP candidates. In some embodiments, N_S Sub-PU TMVP candidates are added into the candidate list, assuming there are M_C candidates in the candidate list in total, M_C≥N_S. The algorithm used to derive each Sub-PU TMVP candidate i (i=1, 2, . . . , N_S) is denoted as algo_i. For different Sub-PU TMVP candidates (For example, Sub-PU TMVP candidate i and Sub-PU TMVP candidate j, i and j are different), algo_i can be different from algo_j.

### IV. Example Video Encoder

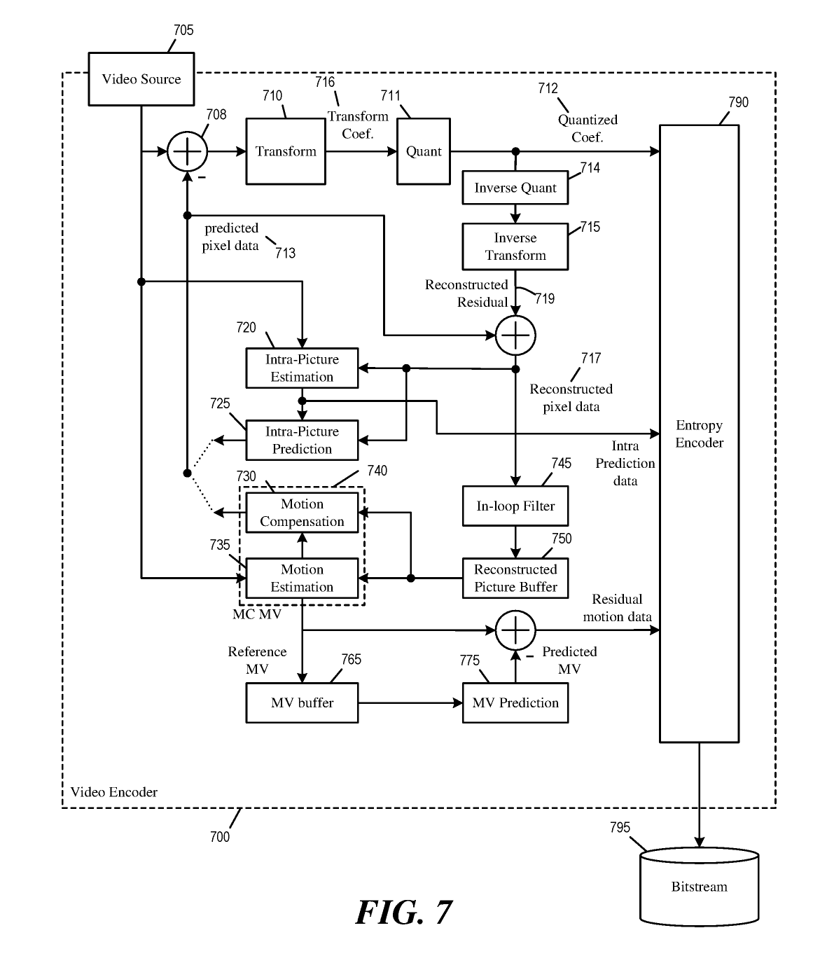

FIG. 7 illustrates an example video encoder 700 that assigns a mode setting (e.g., LIC flag) to a current block of pixels based on mode settings of neighboring blocks associated with candidate predictors. As illustrated, the video encoder 700 receives input video signal from a video source 705 and encodes the signal into bitstream 795. The video encoder 700 has several components or modules for encoding the signal from the video source 705, including a transform module 710, a quantization module 711, an inverse quantization module 714, an inverse transform module 715, an intra-picture estimation module 720, an intra-prediction module 725, a motion compensation module 730, a motion estimation module 735, an in-loop filter 745, a reconstructed picture buffer 750, a MV buffer 765, and a MV prediction module 775, and an entropy encoder 790. The motion compensation module 730 and the motion estimation module 735 are part of an inter-prediction module 740.

In some embodiments, the modules 710-790 are modules of software instructions being executed by one or more processing units (e.g., a processor) of a computing device or electronic apparatus. In some embodiments, the modules 710-790 are modules of hardware circuits implemented by one or more integrated circuits (ICs) of an electronic apparatus. Though the modules 710-790 are illustrated as being separate modules, some of the modules can be combined into a single module.

The video source 705 provides a raw video signal that presents pixel data of each video frame without compression. A subtractor 708 computes the difference between the raw video pixel data of the video source 705 and the predicted pixel data 713 from the motion compensation module 730 or intra-prediction module 725. The transform module 710 converts the difference (or the residual pixel data or residual signal 709) into transform coefficients (e.g., by performing Discrete Cosine Transform, or DCT). The quantization module 711 quantizes the transform coefficients into quantized data (or quantized coefficients) 712, which is encoded into the bitstream 795 by the entropy encoder 790.

The inverse quantization module 714 de-quantizes the quantized data (or quantized coefficients) 712 to obtain transform coefficients, and the inverse transform module 715 performs inverse transform on the transform coefficients to produce reconstructed residual 719. The reconstructed residual 719 is added with the predicted pixel data 713 to produce reconstructed pixel data 717. In some embodiments, the reconstructed pixel data 717 is temporarily stored in a line buffer (not illustrated) for intra-picture prediction and spatial MV prediction. The reconstructed pixels are filtered by the in-loop filter 745 and stored in the reconstructed picture buffer 750. In some embodiments, the reconstructed picture buffer 750 is a storage external to the video encoder 700. In some embodiments, the reconstructed picture buffer 750 is a storage internal to the video encoder 700.

The intra-picture estimation module 720 performs intra-prediction based on the reconstructed pixel data 717 to produce intra prediction data. The intra-prediction data is provided to the entropy encoder 790 to be encoded into bitstream 795. The intra-prediction data is also used by the intra-prediction module 725 to produce the predicted pixel data 713.

The motion estimation module 735 performs inter-prediction by producing MVs to reference pixel data of previously decoded frames stored in the reconstructed picture buffer 750. These MVs are provided to the motion compensation module 730 to produce predicted pixel data.

Instead of encoding the complete actual MVs in the bitstream, the video encoder 700 uses MV prediction to generate predicted MVs, and the difference between the MVs used for motion compensation and the predicted MVs is encoded as residual motion data and stored in the bitstream 795.

The MV prediction module 775 generates the predicted MVs based on reference MVs that were generated for encoding previously video frames, i.e., the motion compensation MVs that were used to perform motion compensation. The MV prediction module 775 retrieves reference MVs from previous video frames from the MV buffer 765. The video encoder 700 stores the MVs generated for the current video frame in the MV buffer 765 as reference MVs for generating predicted MVs.

The MV prediction module 775 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 795 by the entropy encoder 790.

The entropy encoder 790 encodes various parameters and data into the bitstream 795 by using entropy-coding techniques such as context-adaptive binary arithmetic coding (CABAC) or Huffman encoding. The entropy encoder 790 encodes parameters such as quantized transform data and residual motion data into the bitstream 795. The bitstream 795 is in turn stored in a storage device or transmitted to a decoder over a communications medium such as a network.

The in-loop filter 745 performs filtering or smoothing operations on the reconstructed pixel data 717 to reduce the artifacts of coding, particularly at boundaries of pixel blocks. In some embodiments, the filtering operation performed includes sample adaptive offset (SAO). In some embodiment, the filtering operations include adaptive loop filter (ALF).

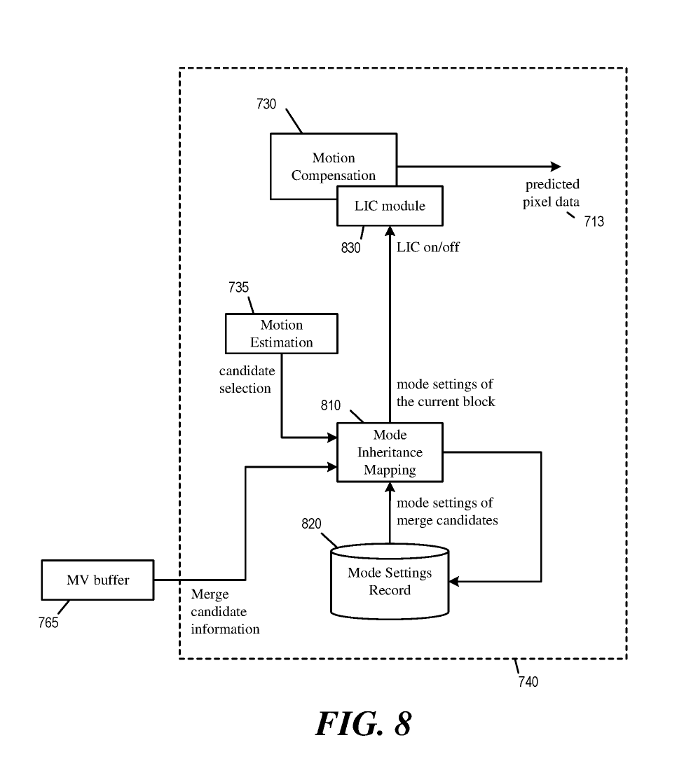

FIG. 8 illustrates a portion of the video encoder 700 that assigns a mode setting to a current block of pixels. As illustrated, the inter-prediction module 740 includes a mode inheritance mapping module 810. The mode inheritance mapping module 810 receives merge candidate information from the MV buffer 765 as well as a candidate selection signal from the motion estimation module 735. The mode inheritance mapping module 810 also receives the mode settings of various merge candidates from a mode setting record 820. The mode setting record 820 may be part of the MV buffer 765 or is in a separate storage device. The mode settings of each spatial or temporal neighbor is linked with the merge candidate information of the neighbor, e.g., by being part of a common data structure.

The mode inheritance mapping module 810 determines the mode setting of the current block based on the candidate selection and the mode settings of the spatial and temporal neighbors. For example, the mode inheritance mapping module 810 may toggle the mode settings of certain merge candidates according to a predefined rule. The current block may inherit a toggled mode setting if the corresponding merge candidate is the selected merge candidate.

The determined mode setting of the current block is stored as part of the mode settings record 820 for coding subsequent blocks. The mode setting of the current block is also provided to the motion compensation module 730, which includes a LIC module 830. The mode setting of the current block may turn on or turn off the operations of the LIC module 830 for the current block. If LIC mode is turned on, the LIC module 830 generates and applies the linear model to modify the output of the motion compensation module 730 as the predicted pixel data 713.

### V. Example Video Decoder

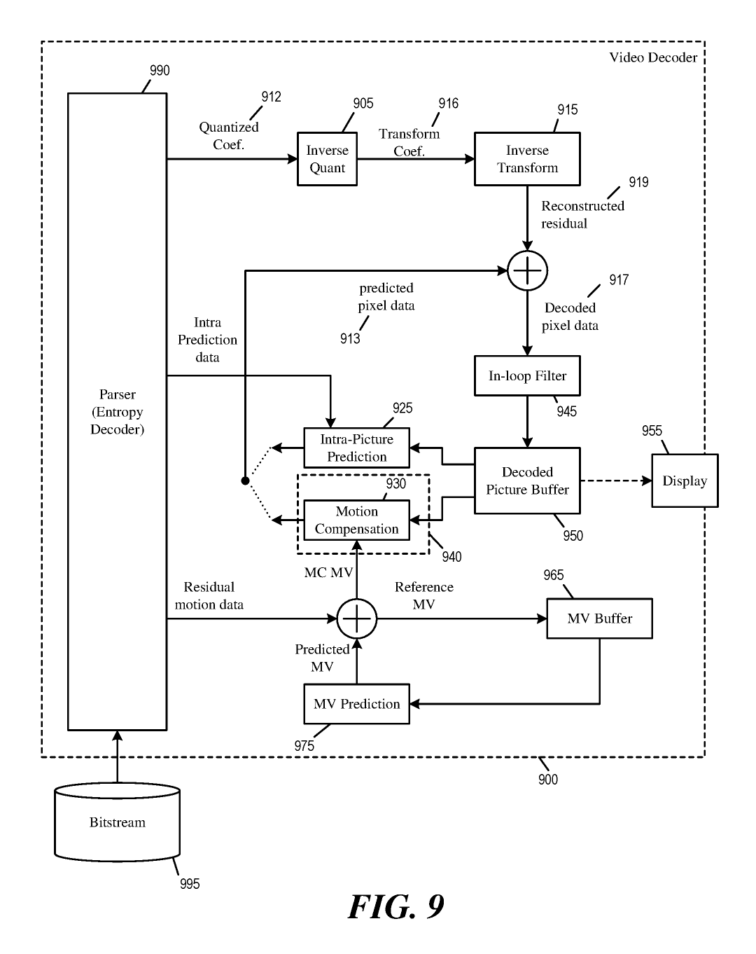

FIG. 9 illustrates an example video decoder 900 that assigns a mode setting (e.g., LIC flag) to a current block of pixels based on mode settings of neighboring blocks associated with candidate predictors. As illustrated, the video decoder 900 is an image-decoding or video-decoding circuit that receives a bitstream 995 and decodes the content of the bitstream into pixel data of video frames for display. The video decoder 900 has several components or modules for decoding the bitstream 995, including an inverse quantization module 905, an inverse transform module 915, an intra-prediction module 925, a motion compensation module 930, an in-loop filter 945, a decoded picture buffer 950, a MV buffer 965, a MV prediction module 975, and a parser 990. The motion compensation module 930 is part of an inter-prediction module 940.

In some embodiments, the modules 910-990 are modules of software instructions being executed by one or more processing units (e.g., a processor) of a computing device. In some embodiments, the modules 910-990 are modules of hardware circuits implemented by one or more ICs of an electronic apparatus. Though the modules 910-990 are illustrated as being separate modules, some of the modules can be combined into a single module.

The parser 990 (or entropy decoder) receives the bitstream 995 and performs initial parsing according to the syntax defined by a video-coding or image-coding standard. The parsed syntax element includes various header elements, flags, as well as quantized data (or quantized coefficients) 912. The parser 990 parses out the various syntax elements by using entropy-coding techniques such as context-adaptive binary arithmetic coding (CABAC) or Huffman encoding.

The inverse quantization module 905 de-quantizes the quantized data (or quantized coefficients) 912 to obtain transform coefficients, and the inverse transform module 915 performs inverse transform on the transform coefficients 916 to produce reconstructed residual signal 919. The reconstructed residual signal 919 is added with predicted pixel data 913 from the intra-prediction module 925 or the motion compensation module 930 to produce decoded pixel data 917. The decoded pixels data are filtered by the in-loop filter 945 and stored in the decoded picture buffer 950. In some embodiments, the decoded picture buffer 950 is a storage external to the video decoder 900. In some embodiments, the decoded picture buffer 950 is a storage internal to the video decoder 900.

The intra-prediction module 925 receives intra-prediction data from bitstream 995 and according to which, produces the predicted pixel data 913 from the decoded pixel data 917 stored in the decoded picture buffer 950. In some embodiments, the decoded pixel data 917 is also stored in a line buffer (not illustrated) for intra-picture prediction and spatial MV prediction.

In some embodiments, the content of the decoded picture buffer 950 is used for display. A display device 955 either retrieves the content of the decoded picture buffer 950 for display directly, or retrieves the content of the decoded picture buffer to a display buffer. In some embodiments, the display device receives pixel values from the decoded picture buffer 950 through a pixel transport.

The motion compensation module 930 produces predicted pixel data 913 from the decoded pixel data 917 stored in the decoded picture buffer 950 according to motion compensation MVs (MC MVs). These motion compensation MVs are decoded by adding the residual motion data received from the bitstream 995 with predicted MVs received from the MV prediction module 975.

The MV prediction module 975 generates the predicted MVs based on reference MVs that were generated for decoding previous video frames, e.g., the motion compensation MVs that were used to perform motion compensation. The MV prediction module 975 retrieves the reference MVs of previous video frames from the MV buffer 965. The video decoder 900 stores the motion compensation MVs generated for decoding the current video frame in the MV buffer 965 as reference MVs for producing predicted MVs.

The in-loop filter 945 performs filtering or smoothing operations on the decoded pixel data 917 to reduce the artifacts of coding, particularly at boundaries of pixel blocks. In some embodiments, the filtering operation performed includes sample adaptive offset (SAO). In some embodiment, the filtering operations include adaptive loop filter (ALF).

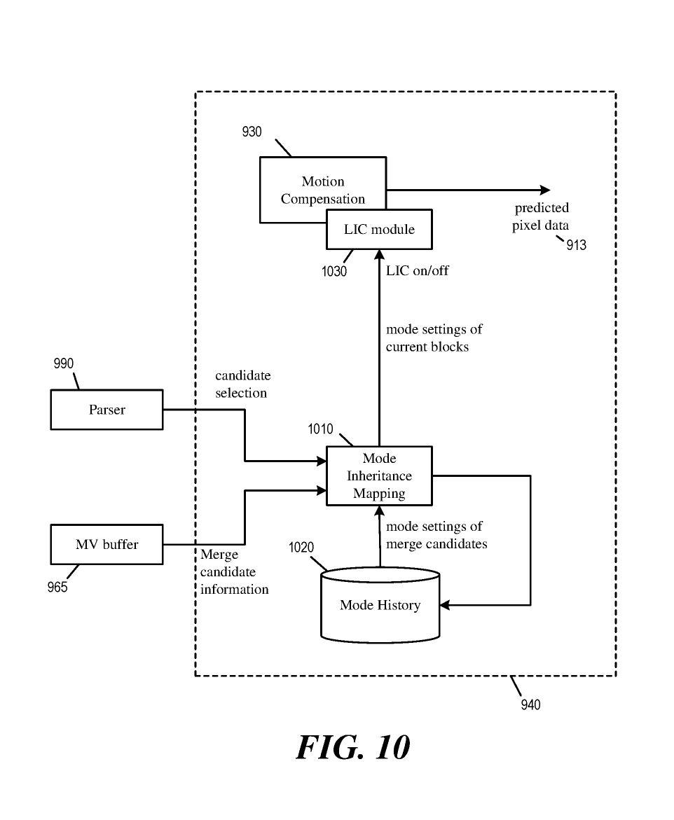

FIG. 10 illustrates a portion of the video decoder 900 that assigns a mode setting to a current block of pixels. As illustrated, the inter-prediction module 940 includes a mode inheritance mapping module 1010. The mode inheritance mapping module 1010 receives merge candidate information from the MV buffer 965 as well as a candidate selection signal from the parser 990. The mode inheritance mapping module 1010 also receives the mode settings of various merge candidates from a mode setting record 1020. The mode setting record 1020 may be part of the MV buffer 965 or is in a separate storage device. The mode settings of each spatial or temporal neighbor is linked with the merge candidate information of the neighbor, e.g., by being part of a common data structure.

The mode inheritance mapping module 1010 determines the mode setting of the current block based on the candidate selection and the mode settings of the spatial and temporal neighbors. For example, the mode inheritance mapping module may toggle the mode settings of certain merge candidates according to a predefined rule. The current block may inherit a toggled mode setting if the corresponding merge candidate is the selected merge candidate.

The determined mode setting of the current block is stored as part of the mode settings record 1020 for coding subsequent blocks. The mode setting of the current block is also provided to the motion compensation module 930, which includes a LIC module 1030. The mode setting of the current block may turn on or turn off the operations of the LIC module 1030 for the current block. If LIC mode is turned on, the LIC module 1030 generates and applies the linear model to modify the output of the motion compensation module 930 as the predicted pixel data 913.

### VI. Example Process

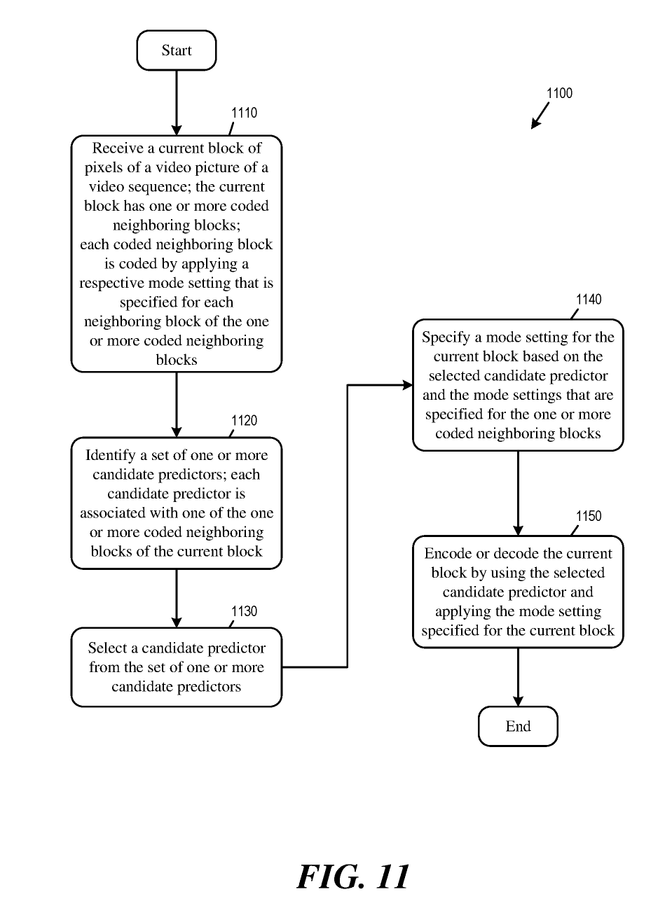

FIG. 11 conceptually illustrates a process 1100 for assigning a mode setting to a current block of pixels based on mode settings of neighboring blocks associated with merge candidates. In some embodiments, one or more processing units (e.g., a processor) of a computing device implementing a video codec (e.g., the video encoder 700 or the video decoder 900) performs the process 1100 by executing instructions stored in a computer readable medium. In some embodiments, an electronic apparatus implementing the video codec performs the process 1100. The video codec performs the process 1100 when it is encoding or decoding a video sequence.

The video codec receives (at step 1110) a block of pixels of a video picture of the video sequence as the current block to be coded. The current block has one or more neighboring blocks that are already coded. Each coded neighboring block is coded by applying a respective mode setting that is specified for each neighboring block of the one or more coded neighboring blocks. The neighboring blocks include spatial neighbors (e.g., A0, A3, B0, B1, B2) and temporal neighbors (e.g., TCTR, TRT, TLB, and TRB). Each coded neighboring block of the current block is coded by applying a mode setting that is specified for the neighboring block. The mode setting of a neighboring block specifies whether a function or operation such as LIC or NPO is performed when the neighboring block is coded.

The video codec identifies (at step 1120) a set of one or more candidate predictors. Each candidate predictor is associated with one of the one or more coded neighboring blocks of the current block. A candidate predictor may be a merge candidate from a list of merge candidates. The video codec then selects (at step 1130) a candidate predictor from the set of one or more candidate predictors. The selected candidate predictor is associated with at least one of the coded neighboring blocks of the current block.

The video codec specifies (at step 1140) or assigns a mode setting for the current block based on the selected candidate predictor and the mode settings that are specified for the coded neighboring blocks. The mode setting of the neighboring block of the selected candidate is inherited by the current block.

In some embodiments, the settings of one or more neighboring blocks or merge candidates are toggled for the current block to inherit according to a predefined rule. In some embodiments, the mode setting specified for the current block of pixels is a toggle of the respective mode setting specified for one or the one or more coded neighboring blocks that is associated with the selected candidate predictor. The video codec may identify a subset of one or more candidate predictors among the set of one or more candidate predictors according to a predetermined rule. The mode setting specified for the current block of pixels is a toggle of the mode setting specified for one of the one or more coded neighboring blocks that is associated with the selected candidate predictor when the selected candidate predictor is in the identified subset.

In some embodiments, when the mode settings specified for respective one or more of the one or more coded neighboring blocks associated with the subset of candidate predictors share a same value and when the selected candidate predictor is in the identified subset of one or more candidate predictors, the mode setting specified for the current block of pixels is a toggle of the mode setting specified for one of the one or more coded neighboring blocks that is associated with the selected candidate predictor.

In some embodiments, the list of merge candidates may include one or more Sub-PU TMVPs and the selected merge candidate may be a Sub-PU TMVP. The selected candidate predictor may have motion information for multiple sub-blocks of the current block of pixels. The identified subset of one or more candidate predictors may include two or more candidate predictors having motion information for a plurality of sub-blocks of the current block of pixels.

In some embodiments, the mode setting specified for the current block of pixels is determined based on a count of neighboring blocks of the one or more coded neighboring blocks sharing a same value for their respective mode settings.

The assignment of mode setting of the current block based on mode settings of candidate predictors is described in detail in Section I above.

The video codec encodes or decodes (at step 1150) the current block by using the selected candidate predictor and applying the mode setting specified for the current block. For some embodiments in which the mode setting is for LIC, the video codec derives a LIC linear model for the current block by computing the scaling factor “a” and the offset “b” based on spatially neighboring pixels of the current block. The video codec then applies the linear model when reconstructing or decoding the current block. The derivation of the LIC linear model is described in Section II above. The process 1100 ends and the video codec proceeds to encode or decode another block of pixels of the current picture or another video picture of the video sequence.

### VII. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

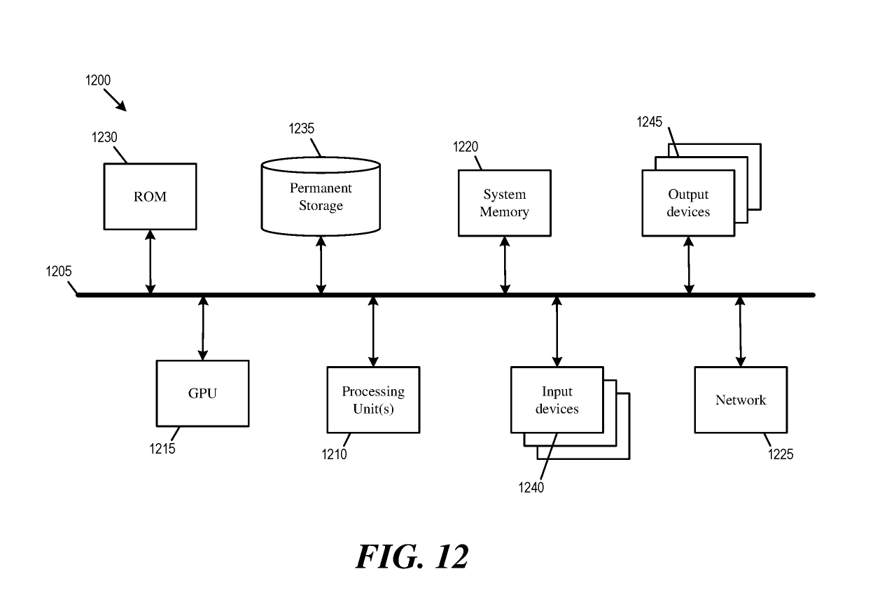

FIG. 12 conceptually illustrates an electronic system 1200 with which some embodiments of the present disclosure are implemented. The electronic system 1200 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1200 includes a bus 1205, processing unit(s) 1210, a graphics-processing unit (GPU) 1215, a system memory 1220, a network 1225, a read-only memory 1230, a permanent storage device 1235, input devices 1240, and output devices 1245.

The bus 1205 collectively represents all system, peripheral, and chipset buses that communicatively connect the numerous internal devices of the electronic system 1200. For instance, the bus 1205 communicatively connects the processing unit(s) 1210 with the GPU 1215, the read-only memory 1230, the system memory 1220, and the permanent storage device 1235.

From these various memory units, the processing unit(s) 1210 retrieves instructions to execute and data to process in order to execute the processes of the present disclosure. The processing unit(s) may be a single processor or a multi-core processor in different embodiments. Some instructions are passed to and executed by the GPU 1215. The GPU 1215 can offload various computations or complement the image processing provided by the processing unit(s) 1210.

The read-only-memory (ROM) 1230 stores static data and instructions that are needed by the processing unit(s) 1210 and other modules of the electronic system. The permanent storage device 1235, on the other hand, is a read-and-write memory device. This device is a non-volatile memory unit that stores instructions and data even when the electronic system 1200 is off. Some embodiments of the present disclosure use a mass-storage device (such as a magnetic or optical disk and its corresponding disk drive) as the permanent storage device 1235.

Other embodiments use a removable storage device (such as a floppy disk, flash memory device, etc., and its corresponding disk drive) as the permanent storage device. Like the permanent storage device 1235, the system memory 1220 is a read-and-write memory device. However, unlike storage device 1235, the system memory 1220 is a volatile read-and-write memory, such a random access memory. The system memory 1220 stores some of the instructions and data that the processor needs at runtime. In some embodiments, processes in accordance with the present disclosure are stored in the system memory 1220, the permanent storage device 1235, and/or the read-only memory 1230. For example, the various memory units include instructions for processing multimedia clips in accordance with some embodiments. From these various memory units, the processing unit(s) 1210 retrieves instructions to execute and data to process in order to execute the processes of some embodiments.

The bus 1205 also connects to the input and output devices 1240 and 1245. The input devices 1240 enable the user to communicate information and select commands to the electronic system. The input devices 1240 include alphanumeric keyboards and pointing devices (also called “cursor control devices”), cameras (e.g., webcams), microphones or similar devices for receiving voice commands, etc. The output devices 1245 display images generated by the electronic system or otherwise output data. The output devices 1245 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 12, bus 1205 also couples electronic system 1200 to a network 1225 through a network adapter (not shown). In this manner, the computer can be a part of a network of computers (such as a local area network (“LAN”), a wide area network (“WAN”), or an Intranet, or a network of networks, such as the Internet. Any or all components of electronic system 1200 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 11) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method for encoding or decoding a frame in a video sequence, the method comprising:
receiving a current block of pixels of a video picture of the video sequence, the current block of pixels having one or more coded neighboring blocks, wherein each coded neighboring block of the one or more coded neighboring blocks is coded by applying a respective mode setting that is specified for each neighboring block of the one or more coded neighboring blocks;
identifying a set of one or more candidate predictors, wherein each candidate predictor of the one or more candidate predictors is associated with one of the one or more coded neighboring blocks of the current block of pixels;
selecting a candidate predictor from the set of one or more candidate predictors;
specifying a mode setting for the current block of pixels based on the selected candidate predictor and mode settings that are specified for the one or more coded neighboring blocks; and
coding the current block of pixels by using the selected candidate predictor and applying the mode setting specified for the current block of pixels.

2. The method of claim 1, wherein the mode setting specified for the current block of pixels is a toggle of the respective mode setting specified for one or the one or more coded neighboring blocks that is associated with the selected candidate predictor.

3. The method of claim 1, further comprising:
identifying a subset of one or more candidate predictors among the set of one or more candidate predictors according to a predetermined rule,
wherein the mode setting specified for the current block of pixels is a toggle of the mode setting specified for one of the one or more coded neighboring blocks that is associated with the selected candidate predictor when the selected candidate predictor is in the identified subset.

4. The method of claim 3, wherein the selected candidate predictor comprises motion information for a plurality of sub-blocks of the current block of pixels.

5. The method of claim 1, further comprising:
identifying a subset of one or more candidate predictors among the set of one or more candidate predictors according to a predetermined rule,
wherein, when the mode settings specified for respective one or more of the one or more coded neighboring blocks associated with the subset of candidate predictors share a same value and when the selected candidate predictor is in the identified subset of one or more candidate predictors, the mode setting specified for the current block of pixels is a toggle of the mode setting specified for one of the one or more coded neighboring blocks that is associated with the selected candidate predictor.

6. The method of claim 5, wherein the identified subset of one or more candidate predictors comprises two or more candidate predictors having motion information for a plurality of sub-blocks of the current block of pixels.

7. The method of claim 1, wherein the mode setting specified for the current block of pixels is determined based on a count of neighboring blocks of the one or more coded neighboring blocks sharing a same value for their respective mode settings.

8. The method of claim 1, wherein the mode setting specified for the current block of pixels is a flag for applying a linear model that includes a scaling factor and an offset to pixel values of the current block of pixels.

9. An electronic apparatus comprising:
a decoder circuit capable of:
receiving a current block of pixels of a video picture of a video sequence, the current block of pixels having one or more coded neighboring blocks, wherein each coded neighboring block of the one or more coded neighboring blocks is coded by applying a respective mode setting that is specified for each neighboring block of the one or more coded neighboring blocks;
identifying a set of one or more candidate predictors, wherein each candidate predictor of the one or more candidate predictors is associated with one of the one or more coded neighboring blocks of the current block of pixels;
selecting a candidate predictor from the set of one or more candidate predictors;
specifying a mode setting for the current block of pixels based on the selected candidate predictor and mode settings that are specified for the one or more coded neighboring blocks; and
decoding the current block of pixels by using the selected candidate predictor and applying the mode setting specified for the current block of pixels.

10. An electronic apparatus comprising:
an encoder circuit capable of:
receiving a current block of pixels of a video picture of the video sequence, the current block of pixels having one or more coded neighboring blocks, wherein each coded neighboring block of the one or more coded neighboring blocks is coded by applying a respective mode setting that is specified for each neighboring block of the one or more coded neighboring blocks;
identifying a set of one or more candidate predictors, wherein each candidate predictor of the one or more candidate predictors is associated with one of the one or more coded neighboring blocks of the current block of pixels;
selecting a candidate predictor from the set of one or more candidate predictors;
specifying a mode setting for the current block of pixels based on the selected candidate predictor and mode settings that are specified for the one or more coded neighboring blocks; and
encoding the current block of pixels by using the selected candidate predictor and applying the mode setting specified for the current block of pixels.
